(19) United States
(12) Patent Application Publication
(10) Pub. No.: US 2016/0151810 A1
(43) Pub. Date: Jun. 2, 2016

(54) METHOD AND SYSTEM TO HEAT SUBMERGED OBJECTS WITH LASER LIGHT

(71) Applicant: ZERLUX HUNGARY LTD., Kecskemet (HU)

(72) Inventor: Tamas Bozso, Kecskemet (HU)

(73) Assignee: ZERLUX HUNGARY LTD, Kecskemet (HU)

(21) Appl. No.: 14/900,072

(22) PCT Filed: Jun. 20, 2014
(86) PCT No.: PCT/IB2014/002233

§ 371 Date: Dec. 18, 2015

(30) Foreign Application Priority Data
Jun. 20, 2013 (HU) P1300392

(51) Int. Cl. B08B 7/00; B08B 9/023; F16L 53/00; B08B 9/027

(52) U.S. Cl. CPC B08B 7/0071; B08B 9/027; B08B 9/023; F16L 53/001

(57) ABSTRACT

A method and system for restoring flow capacity to a submerged fluid conduit comprising a laser light apparatus to generate blue laser light to be impinged on the fluid conduit. The method and system include a frequency multiplier (15) for converting infrared laser light from a laser light generator (14) to blue laser light having a higher transmissivity in seawater. The frequency multiplier may be disposed on a submergible vehicle (2). In one embodiment, a non-submerged infrared laser light generator (14) supplies, via optical conduits (21), laser light to a submerged frequency multiplier (15) on the vehicle (2). Blue laser light, at a wavelength in the range of 440-500 nm, is emitted through an optical window and through seawater to impinge on the surface of the fluid conduit.

### STATEMENT OF RELATED APPLICATIONS

This application claims priority to and depends from Hungarian patent application no. P1300392 filed on 20 Jun. 2013.

### FIELD OF THE INVENTION

This application relates to a method to remove deposits from submerged flow conduits such as pipelines, flow lines, wellheads and related equipment. Such deposits include, but are not limited to, methane hydrates, paraffin, wax and asphaltenes. These materials adhere to the interior and sometimes to the exterior of flow conduits resulting in the formation of flow restrictions and blockages on the interior of flow conduits and resulting in interference with moving components on the exterior of flow conduits. This application relates to a method and a system that can be used to restore fluid flow capacity and operability in a submerged fluid conduit such as a pipeline, flow line or wellhead. More specifically, this application relates to the use of electrical current to produce laser light used to irradiate a portion of a blocked fluid conduit on a seafloor. Irradiation heats the targeted fluid conduit to melt, dissolve, thermally degrade and/or dislodge such deposits. Irradiation may remove a deposit, such as methane hydrates, by heating only a portion of the material deposited on the interior or exterior of the fluid conduit to thereby allow restored flow or restored operability to remove the remainder of restrictions and blockages.

### BACKGROUND

### Background of the Related Art

Wells that are drilled into the earth's crust to access and recover mineral deposits such as oil and gas generally include a wellhead disposed above the earth's crust. Many wellheads are located immediately above the seafloor and fluid conduits, which include flow lines, pipelines and the wellhead, deliver oil and gas production from geologic formations to receiving facilities. Methane hydrate and water promote the formation of methane hydrates within the fluid conduit. Other deposits may adhere to the walls of fluid conduits. The resulting flow restrictions or blockages impair the flow capacity or operability of the fluid conduit and limit recovery.

Solids that form within the fluid conduits may also include, for example, paraffin that is produced with a range of hydrocarbons and preferentially solidifies, adheres and accumulates on an interior bore. Solids deposition may concentrate at restrictions in the fluid conduit including valves, pipe fittings, turns, braches and connectors. Replacement of a blocked portion of a fluid conduit is cost prohibitive because of difficulty of access.

One solution to the problem of impaired flow capacity of fluid conduits is the use of laser-pigging (see for example US 20090205675 A1 and US 20120255933 A1). Laser-pigging involves the use of a pig that can be inserted into and moved through the bore of the blocked or restricted fluid conduit to impinge laser light directly on the blockages or restrictions that have formed within the bore of the fluid conduit. The problem is that a different size of laser-pig is required for the different sizes of flow conduits. Another problem is that the laser-pig must be moved through the bore of the fluid conduit to the location of the blockage or restriction, and the pig must, therefore, have a means of motion within the fluid conduit.

EP2225438 describes a method for restoring flow capacity in a fluid conduit whereby a remotely-controlled electrical drilling tool is inserted into the bore of the restricted or blocked fluid conduit. The drilling tool is then moved through the bore of the fluid conduit using an electrically-powered propulsion system to the location of the restriction or blockage, and a drill bit is activated to drill through the restriction or blockage to restore flow capacity. Electrical resistance heating or an electrically-powered laser may be used in addition to the drilling tool to clear the restriction or blockage.

U.S. Pat. No. 6,343,652 discloses a method and an apparatus for unplugging fluid conduits by moving an electrically-powered heating element is applied against one end of the restriction or blockage and by fluidically displacing heated matter through the fluid conduit and towards the distal end of the restriction or blockage to cause the restriction or blockage to melt.

Other methods use an exothermic chemical reaction to melt a restriction or blockage within the fluid conduit. However, exothermic chemicals may damage or alter the material fluid conduit. U.S. Pat. No. 6,463,925 provides using catalytic hydrogen-oxygen reaction to heat water proximal to the fluid conduit. U.S. Pat. No. 4,154,296 discloses an apparatus for heating a fluid conduit with a heat exchanger installed during construction of the fluid conduit. This increases the cost of manufacture and construction. U.S. Pat. No. 7,367,398 describes a method of warming a fluid conduit by transferring heat to an external layer of insulation formed on the submerged fluid conduit.

WO2001050819 discloses a method of using a microwave system for removing hydrate deposits within a fluid conduit. The microwave heating system is applied in the upstream portion of the fluid conduit using countercurrent microwave propagation at a distance up to, for example, 20 km for a steel fluid conduit.

WO2012116189 discloses a high-power laser transmission system for performing laser irradiation operations to remove deposits from a fluid conduit at locations that are difficult to access and in deep sea environments. This reference describes a theoretical approach for laser treatment to reduce hydrate formation occurring inside hydrocarbon pipelines, whereby the hydrate deposits are subjected to direct heating using a laser device.

WO2013033038 discloses an apparatus for heating a submerged fluid conduit using three-phase alternating current heaters disposed within a chamber. U.S. Publication no. 20130098625 also present methods of restoring flow capacity to a fluid conduit by inductive heating of the fluid conduit.

### BRIEF SUMMARY

One embodiment of the present invention provides a method of warming a submerged fluid conduit to remove a deposit of material comprising providing an electrical current source, providing an umbilical including an electrical conduit having a first end connected to the electrical current source and a second end, providing a submergible apparatus including an electrically-powered laser light generator connected to the second end of the electrical conduit and an optical frequency multiplier to condition laser light from the laser light generator that is introduced into the optical frequency multiplier, submerging the submergible apparatus in a body of water in which the fluid conduit is submerged for transporting fluid from a fluid source to a fluid destination, conducting an electrical current from the current source through the electrical conduit of the umbilical to the laser light generator, generating laser light using the laser light generator, introducing the laser light from the generator into the optical frequency multiplier to produce blue laser light, directing the blue laser light from the submergible apparatus to impinge onto an exterior surface of the fluid conduit to irradiate the fluid conduit, and warming at least a portion of the fluid conduit using the impinging blue laser light. An embodiment of the method may further comprise warming at least a portion of the fluid conduit using the impinging blue laser light to melt a methane hydrate deposit formed within the warmed portion of the fluid conduit. An embodiment of the method may comprise warming at least a portion of the fluid conduit using the impinging blue laser light to warm a volume of the fluid within the fluid conduit and flowing from the fluid source of the fluid conduit to the fluid destination of the fluid conduit to at least one of melt and deter formation of methane hydrates in a downstream portion of the fluid conduit. An embodiment of the method may further comprise providing a controllably positionable optical element to receive the blue laser light produced by the optical frequency multiplier, moving the optical element to vary the path of the blue laser light produced by the optical frequency multiplier and irradiating a plurality of locations along the fluid conduit. An embodiment of the method may comprise providing a camera on the submergible apparatus to generate a signal relating to the appearance of the irradiated portion of the fluid conduit, and providing within the umbilical a camera signal conduit having a first end and a second end connected to the camera within the umbilical to transmit the signal generated by the camera. An embodiment of the method may further comprise connecting a monitor to the first end of the camera signal conduit to receive signals from the camera, and monitoring the appearance of the irradiated portion of the fluid conduit using the monitor. An embodiment of the method may further comprise providing a controller to control the position of the optical element and to thereby vary the path of the blue laser light produced by the optical frequency multiplier, and providing within the umbilical a controller control signal conduit having a first end connected to the controller and a second end connected to the controllably positionable optical element.

Embodiments of the method of the present invention may be used to remove a deposit without melting, thermally degrading, dissolving and/or dislodging all or even a substantial portion of the deposit. An embodiment of the method may further comprise moving the controllably positionable optical element to trace the impingement of the blue laser light longitudinally along a component of a fluid conduit generally corresponding to the direction of flow of fluid therethrough to create a longitudinal channel along the periphery of a blockage within the component of the fluid conduit. Embodiments of the method may further comprise at least one of reducing and equalizing the pressure differential across the blockage within the component of the fluid conduit by creation of the longitudinal channel, and continuing to move the controllably positionable optical element to trace the impingement of the blue laser light on the fluid conduit.

Embodiments of the method of the present invention may comprise providing an electrical current source, providing an electrically-powered laser light generator, providing an umbilical including an optical conduit having a first end connected to the laser light generator and a second end, providing a submergible remotely operated vehicle having an optical frequency multiplier connected to the second end of the optical conduit to condition the laser light from the laser light generator provided through the optical conduit, submerging the vehicle in a body of water in which the fluid conduit is submerged for transporting fluid from a source to a destination, transmitting laser light generated by the laser light generator through the optical conduit to the optical frequency multiplier of the vehicle, producing blue laser light using the optical frequency multiplier, directing the blue laser light from the vehicle onto an exterior surface of the fluid conduit and warming the fluid conduit using the impinging blue laser light.

Embodiments of the system for warming a submerged fluid conduit affected by deposits of a material of the present invention may comprise a non-submerged electrical power source, a submerged laser light generator on a submergible vehicle an optical frequency multiplier disposed on the submergible vehicle and optically coupled to receive laser light generated by the laser light generator and to convert the received laser light into blue laser light, an umbilical comprising an electrical conduit with a first end connectable to the electrical power source and a second end connectable to the laser light generator, and a submergible laser head to receive the blue laser light from the optical frequency multiplier and to emit a blue laser light beam for transmission through water to irradiate a fluid conduit with blue laser light. Embodiments of the system may further comprise a camera provided on the submergible vehicle to convert an image of the fluid conduit to a camera signal, and a camera signal conduit having a second end connectable to the camera and a first end connectable to a non-submerged display device. Embodiments of the system may further comprise a manipulator arm on the vehicle to position the laser head for directing of the blue laser beam transmitted therethrough, an actuator for positioning the manipulator arm, an actuator control signal conduit having a second end connectable to the actuator, and a non-submerged controller connectable to a first end of the actuator control signal conduit for generating signals to the actuator for positioning the laser head to direct blue laser light. Embodiments of the system may further comprise an umbilical including a cable having a first end connectable to a vessel and a second end connectable to the vehicle for supporting the weight of the vehicle and for retrieving the vehicle from a submerged location.

Embodiments of the system for warming a submerged fluid conduit of the present invention may further comprise a non-submerged electrical power source, a non-submerged infrared laser light generator connected to receive electrical current from the electrical power source, an optical frequency multiplier disposed on the submergible vehicle and optically coupled to receive laser light generated by the laser light generator and to convert the received laser light into blue laser light, an umbilical comprising an optically conductive, conduit with a first end connectable to the laser light generator and a second end connectable to the optical frequency multiplier to transmit infrared laser light from the laser light generator to the optical frequency multiplier, and a submergible laser head to receive the blue laser light from the optical frequency multiplier and to emit a blue laser light beam for transmission through water to irradiate a fluid conduit with blue laser light. Embodiments of the system may further comprise a camera provided on the submergible vehicle to convert an image of the fluid conduit to a camera signal, and a camera signal conduit having a second end connectable to the camera and a first end connectable to a non-submerged display device. Embodiments of the system may further comprise a manipulator arm on the vehicle to position the laser head for directing of the blue laser beam transmitted therethrough, an actuator for positioning the manipulator arm, an actuator control signal conduit having a second end connectable to the actuator, and a non-submerged controller connectable to a first end of the actuator control signal conduit for generating signals to the actuator for positioning the laser head to direct blue laser light. Embodiments of the system may further comprise an umbilical further including a cable having a first end connectable to a vessel and a second end connectable to the vehicle for supporting the weight of the vehicle and for retrieving the vehicle from a submerged location.

### BRIEF DESCRIPTION OF THE SEVERAL VIEWS OF THE DRAWINGS

FIG. 1 is a chart illustrating the capacity of water to absorb light at a range of wavelengths.

FIG. 2 is a chart illustrating the capacity of an optical conduit to absorb light at a range of wavelengths.

FIG. 3 illustrates a device for interlacing the light from a plurality of laser diodes and directing the interlaced light in an optical conduit.

FIG. 4 is a perspective view of a remotely operated vehicle that may be used to implement an embodiment of the method and system of the present invention.

FIG. 5 illustrates an optical system securable to a vehicle for directing and focusing laser light introduced into a laser head.

FIG. 6 illustrates an active laser head impinging laser light on a submerged fluid conduit.

FIG. 7 illustrates an alternative apparatus for positioning optical conduits having a plurality of laser heads.

FIG. 8 illustrates a laser head including a guided light beam.

FIG. 9 illustrates a vehicle used to heat a portion of a submerged fluid conduit.

FIG. 10 illustrates the use of blue laser light to heat a submerged iron plate modeling as a portion of a wall of a fluid conduit.

FIG. 11 is a chart of the results of the experiment illustrated in FIG. 10.

FIG. 12 is a methane hydrate stability chart.

FIG. 13 a perspective view of a methane hydrate blockage formed within a fluid conduit.

FIG. 14 is an end view of the blockage of FIG. 13.

### DETAILED DESCRIPTION

A fluid conduit used to transport fluids on a seafloor may include wellheads, flow lines, pipelines, gathering lines used to transport oil, condensate and gas, and specifically includes the many valves, BOPs, fittings, joints, turns, meters, and headers. Hydrates and paraffin and other solids often deposit on the interior of these components of fluid conduits.

Embodiments of the present invention provide a method and a system to remove or reduce hydrate and paraffin restrictions and blockages in or on submerged fluid conduits by impinging blue laser light on the fluid conduit to heat the fluid conduit and the restriction therein or thereon. The fluid conduit is metal, and the localized heat of the blue laser light impingement is quickly dissipated through both the metal of the fluid conduit and through the water that surrounds it. A high-power laser can, under the right circumstances, produce sufficient heating of the fluid conduit and the material within it or on it to melt, dissolve thermally degrade and/or dislodge the deposited, which may form a blockage material. If a differential pressure exists across a blockage, only a small amount of heating may be needed. It should be noted that, depending on the nature and character of the material of the deposit, a temperature increase of only 3 to 5 degrees Celsius may be sufficient to initiate dissolution and/or dislodgement of a restriction or blockage because it allows, for example, intrusion of a warming medium, restoration of flow or operability that either produces additional heat or dislodges additional deposited material. Conversely, if there is a potentially dangerous pressure differential across an internal blockage, methods and systems of the present invention may be used to controllably relieve the pressure differential by removing a channel within the blockage to restore a small amount of flow to equalize the pressure or to at least diminish the pressure differential.

The method and system of the present invention provides for controllably irradiating a preplanned pattern or trace on the exterior of a submerged fluid conduit to irradiate and heat the fluid conduit without damaging or altering the material of the fluid conduit. It will be understood that some components are less likely to be damaged or altered by laser light impingement than others. For example, a wellhead blow-out preventer may have a casing that is over 2 cm in thickness for conducting heat quickly from the impingement site. Other components of the fluid conduit, such as a flow line, may have a relatively thin wall and substantially less conduction capacity. The duration and intensity of blue laser light impingement is preplanned and/or remotely controllable. Other factors that affect the planning of optimal power level and exposure duration of exposure include the sea temperature and absorptivity of the seawater.

In one embodiment of the method and system of the present invention, electrical current is supplied from a non-submerged electrical current source such as, for example, a conventional generator, to a laser light generator on board a submerged vehicle, which may be a remotely controlled vehicle, which are known in the marine and oil and gas industries. The non-submerged electrical current source may be a generator located aboard a marine vessel or on or adjacent to nearby land. Electrical current is conducted from the current source to a laser light generator on board the vehicle through an electrical conductor such as, for example, an insulated metal cable or wire. The electrical conductor may be included within an umbilical for operating and supplying the vehicle. The vehicle comprises an optical frequency multiplier to condition laser light generated by the laser light generator to a preferred wavelength and frequency that can better penetrate water and impinge on the targeted fluid conduit due to lower absorptivity of the water.

Water strongly absorbs ultraviolet, yellow, red and infrared electromagnetic radiation so that laser light in these spectral regions that is transmitted through seawater exhibits a comparatively large power loss. Systems that use laser light in these spectral regions are ineffective unless the transmission distance is very small. Conversely, seawater transmits blue laser light with a much smaller absorptivity, and loses only about 3% of its original power for each meter of seawater through which the light is transmitted.

The vehicle including the electrically powered laser light generator and the optical frequency multiplier is advantageously positioned adjacent to the blocked portion of the conduit to impinge blue laser light through the water disposed between a laser head and the fluid conduit. Heat generated in the laser light generator and/or the optical frequency multiplier is sunk in seawater through heat exchangers built into the vehicle.

In an alternative embodiment of the method and system of the present invention, laser light is generated using a non-submerged laser light generator and transmitted through optical conduits such as optically transmitting fibers to an optical frequency multiplier on board a submerged vehicle. The optical conduits may comprise a portion of an umbilical used to control and operate the vehicle. A property of commercially available optical fiber is the absorption of light is lowest in the infrared band (see FIG. 2). By comparison, laser light outside the selected optimal wavelength and frequency range may result in energy loss of two orders of magnitude greater than the loss of energy for infrared light.

Infrared laser light the non-submerged laser light source is generated, or it is conditioned using a non-submerged optical frequency multiplier, to be of a preferred infrared wavelength and frequency selected to minimize power loss due to the absorptivity of the elongate optical conduits. The length of the optical conduits that carry the laser light to the seafloor may be hundreds of meters. The laser light at the preferred and selected wavelength and frequency, infrared laser light, is transmitted from the non submerged laser light source through the optical conduits to the optical frequency multiplier on the vehicle. The laser light is conditioned using the optical frequency multiplier on the vehicle to a second selected wavelength and frequency in the blue portion of the light spectrum that is selected to minimize power loss due to absorptivity of the seawater between the vehicle and the targeted fluid conduit. The vehicle supporting the optical frequency multiplier is positioned to impinge conditioned, blue laser light onto the exterior of the submerged fluid conduit to remove obstructions therein or thereon. Seawater may be used as a sink for the heat generated by the optical frequency multiplier.

Embodiments of the method of the present invention may further include providing on the vehicle a mechanism for supporting and positioning a laser head during blue light irradiation of a fluid conduit. The mechanism includes a connector to support the laser head and one or more pivoting members coupled intermediate the laser head and the connector. It will be understood that a first pivoting member may provide for rotary movement of the laser head in a first plane and a second pivoting member may be used to rotate the laser head in a second plane at a substantial angle to the first. This mechanism enables the blue laser light to be traced along the surface of the fluid conduit containing the blockage.

The vehicle may be used to support and position a plurality of laser heads that operate in tandem or independently. Each laser head comprises an optical window through which blue laser light can pass to impinge on and to transfer heat energy to the exterior surface of the fluid conduit to be heated. An optical window is provided on the laser head and may be adapted for guiding and/or for focusing the laser light for optimal impingement and heat transfer.

Due to the very high thermal conductivity of water and the fluid conduit, and due to the large volume of water present around a submerged fluid conduit, the water and the fluid conduit together limit the maximum temperature to which the fluid conduit can be heated using embodiments of the method and system of the present invention. Strategic positioning and repositioning the laser heads during operation to trace a preplanned blue laser light path on the fluid conduit limits the duration of irradiation of any localized portion of the fluid conduit to provide further protection against material damage or alteration to the fluid conduit.

The rate at which power is supplied to the laser head in the form of blue laser light is at least 0.1 kW. In embodiments of methods and systems of the present invention, the wavelength of the blue laser light provided by the optical frequency multiplier to the laser head is between 400-600 nm, and most preferably in the range 440-500 nm. It be understood that electromagnetic radiation travels at a fixed speed, and that increasing the frequency reduces the wavelength. As a result, the optical frequency multiplier used to condition laser light may, for example, increase the frequency of infrared laser light, while also reducing the wavelength, to convert the infrared laser light into blue laser light.

Similarly, for the transmission of energy in the form of light from the vehicle to the irradiation target, such as a fluid conduit that exhibits signs of having a restriction or blockage therein or thereon, it is important to select a wavelength and frequency combination for laser light that will maximize the rate at which light energy is transmitted to the fluid conduit. Since seawater is the medium through which the laser light is transmitted between the vehicle and the fluid conduit, it is advantageous to convert light energy delivered to the vehicle to a wavelength and frequency combination that will maximize power transfer to the fluid conduit by minimizing power loss due to absorptivity of water.

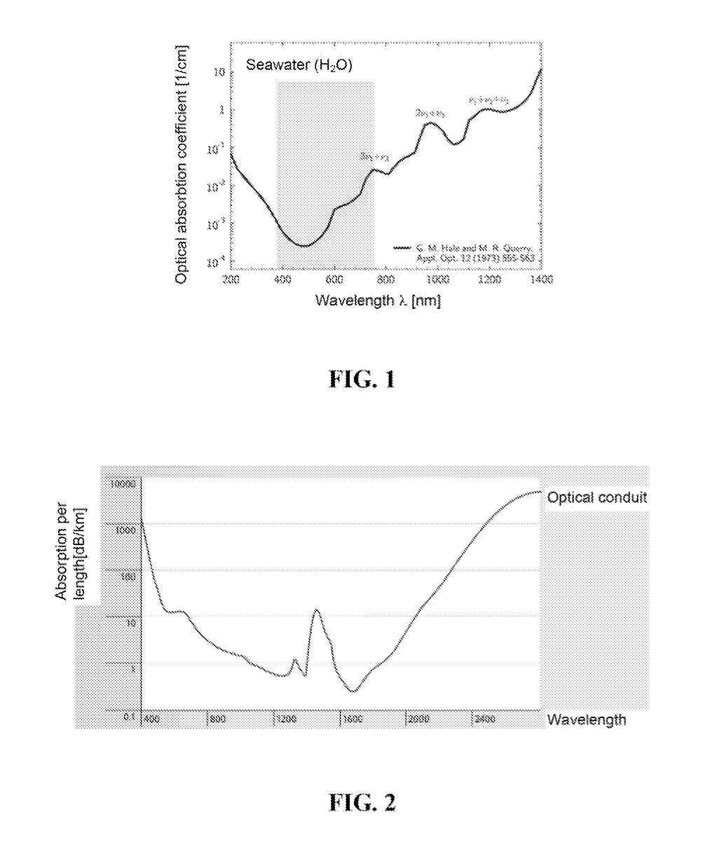

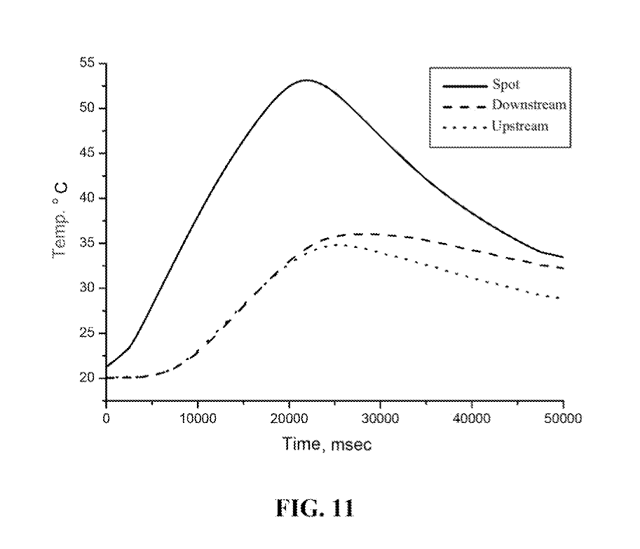

FIG. 1 is a chart illustrating the capacity of seawater to absorb light over a range of wavelengths from 200 to 1400 nm. The physics of embodiments of the method and system of the present invention may be illustrated using absorptivity charts that reveal the wide variance of absorptivities. The gray band on FIG. 11 illustrates the absorptivity of seawater of light within the wavelength and frequency ranges of visible light, which is generally within the range from 400 to 750 nm. It can be seen that minimal absorptivity of light occurs at about 480 nm, which is in the blue region of visible spectrum of light. This means that blue laser light is optimal for minimal absorption of laser light, and minimal loss of power of the laser light, in seawater. This minimal loss can be compared to, for example, infrared light. It is optimal, therefore, to use blue laser light if the laser light is to be transmitted through seawater to the fluid conduit.

Similarly, the material from which fiber optical conduits are made also exhibits absorption of light transmitted therethrough. Absorptivity of the optic conduits is less for certain wavelengths, such as infrared laser light, than for other wavelengths, such as blue or ultraviolet laser light. It is similarly advantageous, therefore, to limit absorption of laser light transmitted through elongate optical conduits to the seafloor by generating and transferring infrared laser light or by converting generated laser light to infrared laser light for transmission through optical conduits to the vehicle at the seafloor where the infrared light is converted in the optical frequency multiplier on the vehicle into blue light for transmission from the vehicle to the targeted fluid conduit to be cleared of deposits, restrictions or blockages. Strategic generation or conversion of laser light for reduced absorption in subsequent transmission (i.e., the transmission of infrared laser light from a land-based laser light generator to the vehicle at the seafloor through optical fiber followed by conversion of the infrared laser light to blue laser light and transmission of blue laser light through seawater to the fluid conduit) enables a substantial gain in performance of up to two or three orders of magnitude for a given power level at the laser light generator as compared to the use of a constant wavelength and frequency of laser light.

It will be understood that the effectiveness of heat transfer to the restricted or blocked fluid conduit using laser light transmission may be monitored and/or gauged using various sensors. For example, but not by way of limitation, the surface temperature of the fluid conduit can be approximated using a camera supported on the vehicle along with the optical frequency multiplier. One camera is the CR110-7 Underwater Camera advertised and described at: http://underwatermonitor.en.ec21.com/CR110-7_Underwater_Camera--4811617_4811632.html). The camera produces a signal providing a visual image that can be transmitted to the surface through a camera signal conduit (which may be a part of an umbilical for operating and controlling the vehicle). Other sensors that may be supported on the vehicle include temperature measurement sensors such as, for example, the Platina temperature sensor, PT1000 Heraeus M1020 32,208,286 advertised and described at http://www.conrad-electronic.co.uk/ce/en/product/171832/Heraeus-32-208-286-M1020-Platinum-Temperature-Sensor-Wired-Pt -1000-70-500-C3850-ppmK-Class-BF0-30-Signal-DIN-E. Other visually detectable conditions may be used to determine the effectiveness of the heat transfer to the fluid conduit using blue laser light. For example, heating the exterior of the fluid conduit results in the heating of any blockage therein but also in the heating of water surrounding the fluid conduit. Decreased water density that accompanies such heating may create a visible current or circulation in the water surrounding the fluid conduit. If the fluid conduit is heated to a sufficient temperature for the water pressure at the seafloor, the water immediately adjacent to the exterior of the fluid conduit may boil, thereby removing a significant amount of heat from the fluid conduit—heat that could be used to heat and remove blockages within the fluid conduit. It will be understood that a camera supported on the vehicle can be used to detect such visual indications, and heat loss can be curtailed by, for example, repeated movement of the location impingement of the blue laser light on the fluid conduit to heat the fluid conduit with high energy density applied at several distributed locations on the fluid conduit to reduce the overall amount of heat removed from the fluid conduit by surrounding water.

Blockages within fluid conduits caused by methane hydrate deposits can be eliminated by localized heating of the exterior of the fluid conduit because methane hydrate decomposes at a temperature above 290° K into liquid water and gaseous methane. Blockages within fluid conduits caused by paraffin deposition can be eliminated by localized heating of the exterior of the fluid conduit because paraffin deposits melt at temperatures above 350° K. It will be understood that complete decomposition of a hydrate blockage or complete melting of a paraffin deposit is not always required. Merely decreasing the viscosity of a paraffin deposit in the amorphous state enables removal of the deposit by the restored liquid flow.

Semiconductor lasers may be used to achieve the best overall heating efficiency. Semiconductor lasers are generally small in size, easy to control and without serviceable parts. The submerged condition of the semiconductor laser makes it practical to remove heat from the laser light source. It will be understood that the use of seawater to remove heat from a semiconductor laser would be applicable only in an embodiment of the method or system of the present invention in which the laser light generator is submerged instead of being non-submerged. Laser light generators that are operated in a non-submerged condition are generally cooled using air or a closed loop fluid cooling system.

In order to select the wavelength of the irradiated light, it is worth observing the water's optical absorption in the function of the wavelength [G. M. Hale and M. R. Querry: Appl. Opt. 12, 555-563 (1973)]. Light with a wavelength of the 380-780 nm (as measured in air) is the least absorbed in water. The optical absorption coefficient is almost two-three orders of magnitude smaller than the absorption of the infrared light conventionally used for heating, such as the around 1070 nm wavelength produced with 30% efficiency Yb-doped fiber laser, or the 800-1060 nm wavelength produced with approximately 50% efficiency semiconductor lasers. To achieve a laser light impingement spot of equal energy density, irradiation of the surface can occur from a distance of one hundred times farther, or by irradiating from the same distance a hundredfold energy density can be achieved when a laser with a wavelength corresponding to a lower optical absorption coefficient is used. Considering this, it is advantageous to use 20% efficiency visible wavelength light source for the job, which has half or one third the efficiency of infrared light.

If the necessary energy to power the entire system is delivered from a device located on the surface to the submerged vehicle with electricity through a metal cable, we can calculate as follows: the efficiency of the laser diodes radiating in that particular wavelength range is of approx. 20%, hence, about four times of the light energy must be discharged in the form of heat through water cooling. Therefore, the required high power (in case of 4.5 kW laser power a total power of 22.5 kW) is provided through electricity from the surface, the required 18 kW cooling is obtained with the water through a heat exchanger, or the heat sink of the laser diodes is incorporated into a location in direct contact with water. In the case where 1000 laser diodes are connected in an electrical series, this (taking into account the operating voltage of 4 V) means 4000 V voltage and 3 A current intensity that can be transmitted to the desired working depth even through a well-insulated thin cable. In the case where the laser diodes are connected differently, e.g. in parallel, then a power supply also needs to be placed near the light source, and the light source can be supplied with alternating current of similar voltage and intensity and of 50 Hz or higher frequency.

A commercially available optical frequency multiplier that can be used to implement embodiments of the method and system of the present invention may include the lithium triborate (LBO) crystal optical frequency multiplier advertised and described at http://eksmaoptics.com/nonlinear-and-laser-crystals/nonlinear-crystals/lithium-triborate-lbo-crystals. The efficiency of the LBO crystal optical frequency multiplier is approximately 30%. The rate at which power is to be delivered to the fluid conduit, along with factors such as heat loss to the surrounding water, power loss from blue laser light due to absorptivity of the water and power loss from infrared laser light due to absorptivity of the optical conduit should all be considered in determining the power rating and setting required for the laser light generator.

The high-power laser beam is produced on location, aboard the vehicle, by concatenation of the light of commercially available 1.5 watt 440-460 nm wavelength laser diodes (e.g., OSRAM PL TB450 and Nichia NDB7875). For the 4.5 kW laser beam described above, the light of 3,000 diodes is needed to be combined into a single laser light beam.

FIG. 2 is a chart illustrating the capacity of a commercially available optical conduit to absorb light at a range of wavelengths. It can be seen in FIG. 2 that minimal absorptivity occurs at about 1,660 nm, which is in the infrared region of the light spectrum.

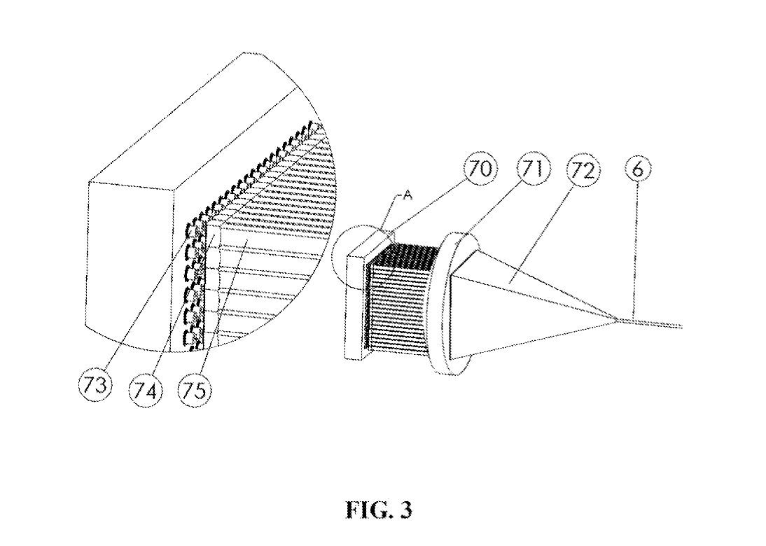

FIG. 3 illustrates a device for interlacing the light from a plurality of laser diodes and directing the interlaced light into an optical conduit. FIG. 3 illustrates an exemplary device suitable for the production of a 4.5 kW laser light beam by concatenation of the light produced by a large plurality of laser diodes 73 and introducing that laser light into a fiber optic cable 6. As shown in FIG. 3, a cooled motherboard 70 supports a large plurality of laser diodes 73. The laser diodes 73 produce laser light that is fed through directional focus collimating lenses 74 to produce parallel light rays 75 that are converted through a convex lens 71 into a single converging beam of light 72. The beam of light 72 is coupled into a fiber optic cable 6. The image to the left in FIG. 3 is an enlarged view of a portion of the device to the right in FIG. 3.

Another preferred embodiment provides a non-submerged laser light generator that generates infrared laser light (wavelength of 800-1200 nm). The infrared laser light is transmitted to a submerged vehicle through one or more optical conduits such as fiber optical cables. Second harmonic generation (SHG, frequency doubling) is used to convert the infrared laser light delivered to the submerged vehicle to blue laser light that minimally absorbed by seawater. This conversion is necessary because the light absorption of the glass fiber of an optical conduit at a frequency optimal for the light transmission in water (blue light) is three orders of magnitude higher than the light absorption of the glass fiber in the infrared region (see FIG. 2.).

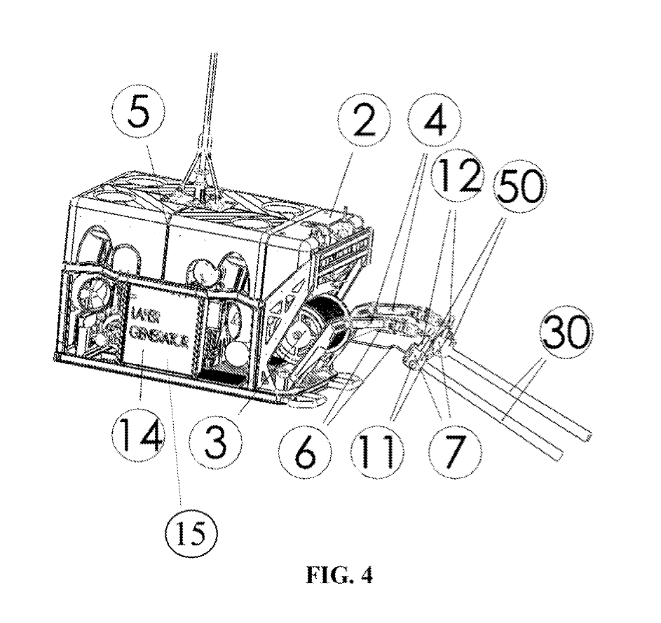

FIG. 4 illustrates a submergible vehicle 2 that can be used to implement embodiments of the method and the system of the present invention. The vehicle illustrated in FIG. 4 is a remotely operated submergible vehicle 2 comprising a fiber optic conduit spool 3 to enable the laser heads 7 to be positioned forward of the vehicle 2 as illustrated in FIG. 4. The vehicle 2 further comprises a pair of manipulator arms 4 that are movable in multiple dimensions in space, an electrical conduit 5 through which power consuming components on board the vehicle can be powered from a non-submerged source of electrical current (not shown), optical conduits 6 connecting the laser light generator 14 and the laser heads 7. An electromagnetic fastener 11 is provided on the vehicle 2 for securing the laser heads 7 to a metal exterior surface of the fluid conduit (not shown) to be irradiated for removal of a blockage. The vehicle 2 further includes an articulatable coupling 12 between each of the laser heads 7 and the manipulator arms 4 on which the laser heads 7 are supported. Upon activation of the laser light generator 14, laser light is conditioned in an optical frequency multiplier 15 and transmitted through the optic conduit on the optical conduit spool 3 to the laser heads 7 to emit a pair of blue laser light beams 30 to impinge on and to irradiate a targeted fluid conduit (not shown) for heating and removal of a blockage therein. Each laser head 7 may further comprise a lens protection window 50 separating a gas-filled optical space within the laser head 7 from the aqueous environment in which the vehicle 2 operates.

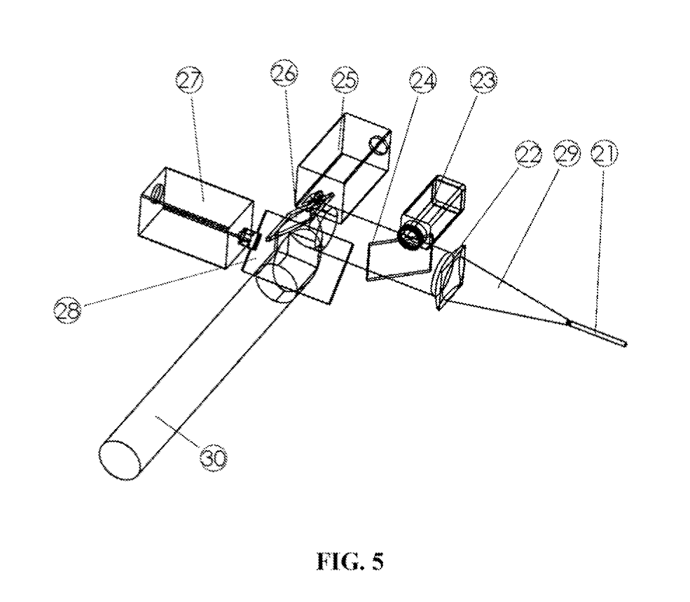

FIG. 5 illustrates an optical system securable to the vehicle 2 (not shown in FIG. 5) for directing and focusing laser light introduced into a laser head 7 (not shown in FIG. 5), In the laser head 7, the path of the laser light beam 30 is controlled using a movable mirror. A divergent laser light beam 29 emitted From an optical conduit 21 is projected onto a reflective face of mirror's 26 and 28 through a collimating and focal length adjusting lens 22. The minors 26 and 28 are movable using electromagnetic motors 25 and 27 (Galvo motor or stepper), and the motors 25 and 27 enable control of the laser light beam 30 for impingement on a fluid conduit (not shown). The size of the irradiated portion on the fluid conduit, which corresponds to the size of the laser light spot on the fluid conduit, can be manipulated using the focal length adjusting lens 22. A polarization semitransparent mirror 24 and a camera 23 may optionally be included in the laser head 7 as shown in FIG. 5. The mirrors 26 and 28 can be moved very rapidly using the motors 25 and 27, so with the use of appropriate image analysis software available through Puretech Systems (see http://www.puretechsystems.com/video-analytics.html) or Agent VI (see http://www.agentvi.com/) or Genetec (see http://www.genetec.com/partners/technology-partner-vagy program/existing-partners/video-analytics-partners), the irradiated portion of the fluid conduit can be controlled by controllable positioning of the impingement site.

The location of the laser light impingement on the targeted fluid conduit can be controlled, using one or more Galvo motors, to trace the laser light impingement site in a pattern along the fluid conduit to prevent excessive exposure of any localized portion of the fluid conduit to laser light.

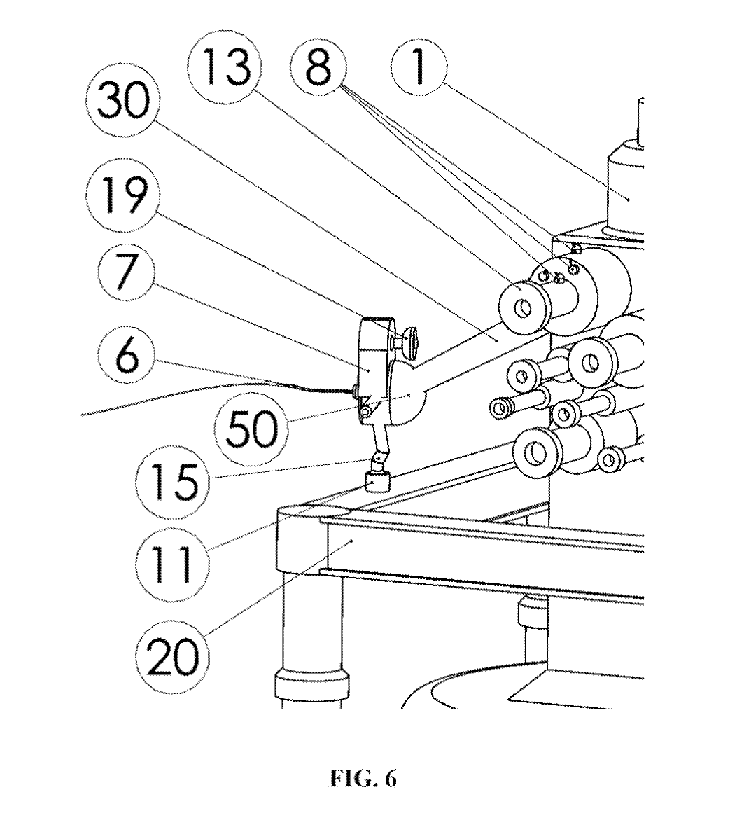

FIG. 6 illustrates an active laser head 7 impinging blue laser light 30 on a submerged fluid conduit 1 which is, in FIG. 6, a blow-out preventer, which is a component of a subsea Christmas tree through which a mineral deposit in a geologic formation may be produced. FIG. 6 further illustrates an optical conduit 6 and a plurality of external temperature sensors 8. The laser head 7 is secured to a protective steel support structure 20 that surrounds the fluid conduit 1 using a magnetic fastener 1 which may be an electromagnetic powered by an electrical conduit included within the optical conduit 6 or a permanent magnet. The laser head 7 in FIG. 6 is positioned for impinging laser light 30 on a valve 13 having a deposit and/or a blockage therein (not shown) to be removed. It will be understood that the deposit may be on the exterior of the fluid conduit 1. An articulating joint 15 disposed intermediate the laser head 7 and the fastener 11 may be set in a desired configuration prior to deployment or in some embodiments, the articulating joint 15 may be remotely controlled. A hydrophone 19 may be provided to enable an operator of the vehicle to detect conditions indicating that the fluid conduit 1 is warming. For example, but not by way of limitation, a restored flow within a fluid conduit 1 would produce audible indications that could be detected by the hydrophone 19. A pressure-resistant transparent barrier 50 may be provided on the laser head 7 to isolate the components of the laser head 7 from the seawater.

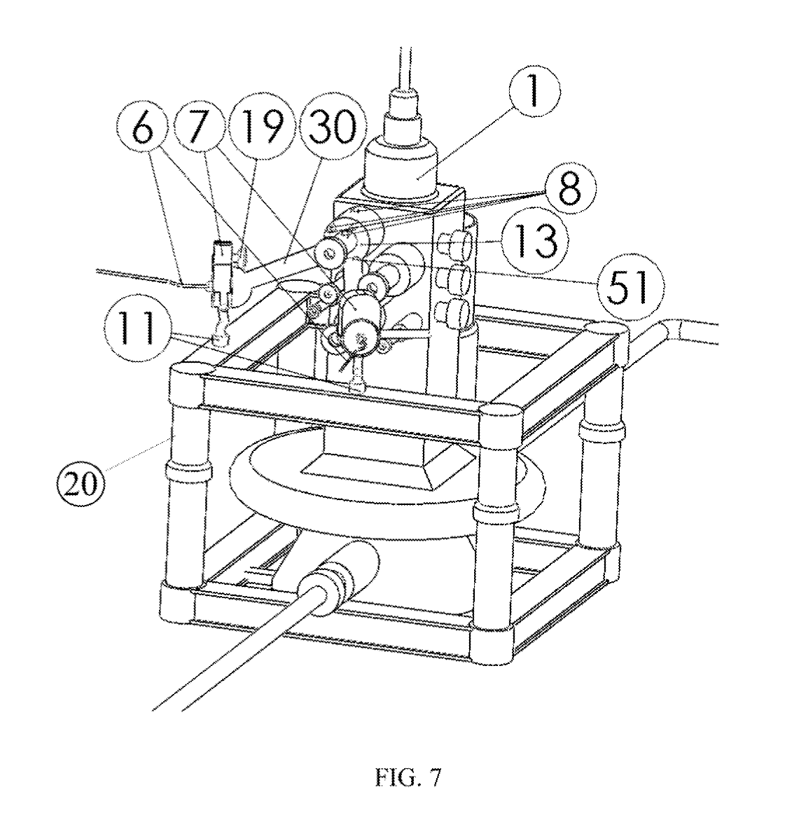

FIG. 7 illustrates an alternative apparatus for positioning a plurality of laser heads 7, each connected to an optical conduit 6. Each of the laser heads 7 are supported on a fastener 11 secured to the protective steel support structure 20 that surrounds the fluid conduit 1 to be heated for heating and removal of a blockage (not shown). A plurality of temperature sensors 8 are disposed on the fluid conduit 1. This arrangement enables faster and more thorough heating of the fluid conduit 1 because a plurality of laser heads 7 impinge laser light at a plurality of angles onto the blocked fluid conduit 1. A hydrophone 19 may be provided to enable the detection of acoustic indications of restored flow within the flow conduit 1.

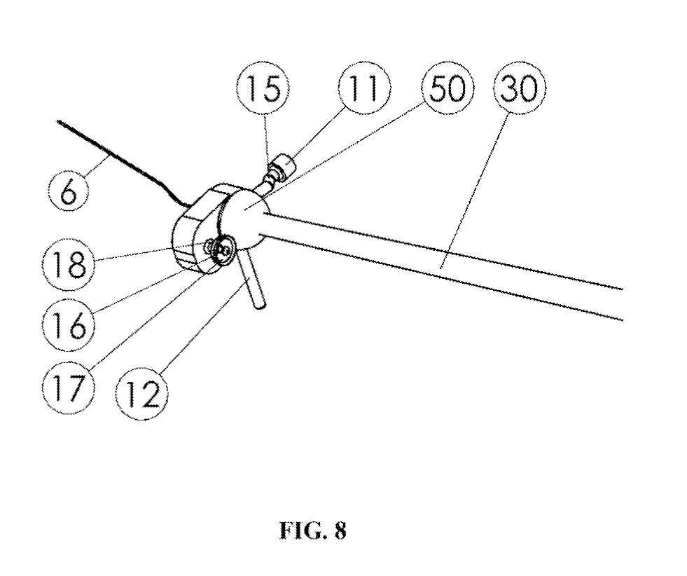

FIG. 8 illustrates a laser head 7 including a guided light beam 30. In a further preferred embodiment, the apparatus comprises at least one acoustic sensor 17 placed on the vehicle and/or in the laser head (see FIG. 8). Optical conduit 6 supplies laser light 30 to the laser head 7. The laser head 7 is supportable by and securable to a metal object (not shown) using a fastener 11, which may be an electromagnet powered by an electrical conduit included within the optical conduit 6 or a permanent magnet. The fastener 11 enables the laser head 7 to be secured to a metal surface, which may be the fluid conduit 1 having a blockage to be removed. A coupling 12 is provided for securing the laser head 7 to a manipulator arm 4 (not shown in FIG. 8). An articulating joint 15, which may be a remotely controllable joint, is disposed intermediate the fastener H and the laser head 7. A lens protection window 50 may be included on the laser head 7 to isolate sensitive components from seawater. A plurality of temperature sensors 16 and 18 are directed at the impingement site and connected to signal conduits (not shown) within the optical conduit 6.

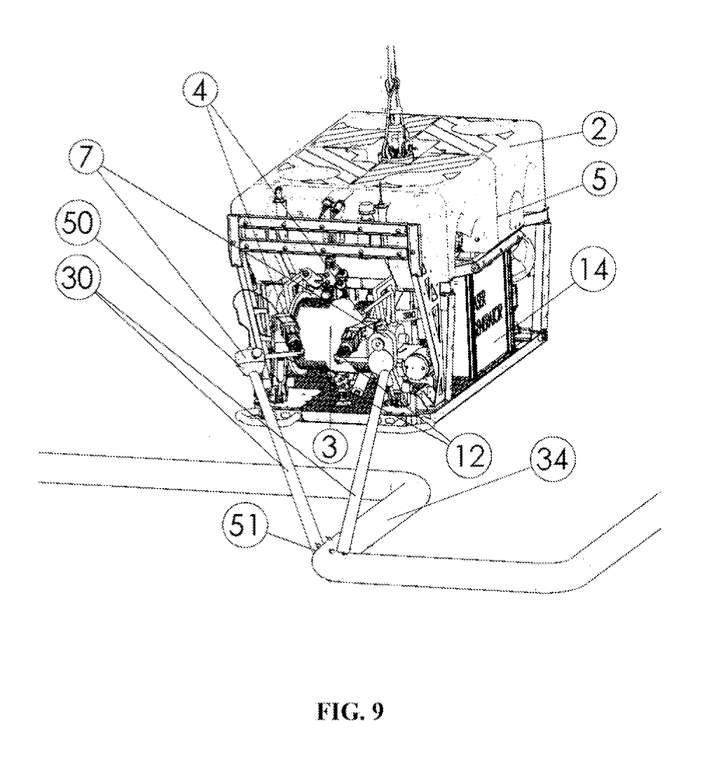

FIG. 9 illustrates a submergible vehicle 2 used to heat a portion of a submerged fluid conduit 34. FIG. 9 illustrates a submergible vehicle 2 that can be used to implement embodiments of the method and system of the present invention. The vehicle 2 of FIG. 9 supports two laser heads 7 used to impinge laser beams 30 onto the fluid conduit 34. The several reference numbers in FIG. 9 are used for the same components as in FIGS. 7 and 8, including the electrical conduit 5, the laser light generator 14, laser light beams 30, protective lense cover 50, manipulator arms 4, and articulatable couplings 12.

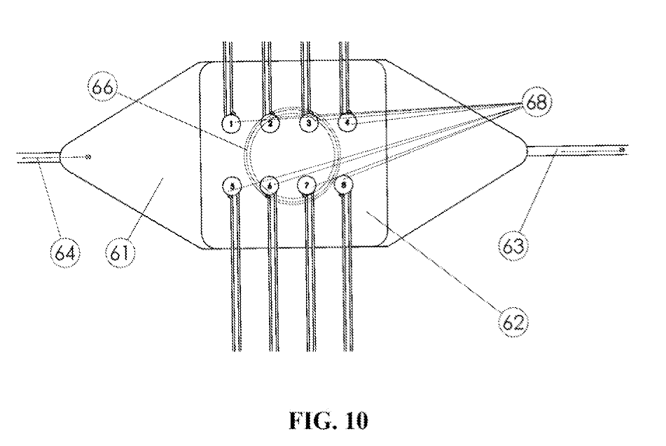

The use of an embodiment of the method and system of the present invention has been tested with successful results. FIG. 10 is a plan view of an iron plate 62 having a thickness of 10 mm. The iron plate 62 is conductively secured to a water passage (behind iron plate 62) having a water inlet 63 and a water outlet 64. A funneling tube 61 is illustrated as being disposed intermediate the Water inlet 63 and the passage (not shown) to which the iron plate 62 is secured and also between the water outlet 64 and the passage (not shown) to which the iron plate 62 is secured. A plurality of temperature sensors 68 are secured to the iron plate 62 to measure the temperature changes that result during the experiment. Blue laser light was impinged on the iron plate 62 as shown by the impingement site 66 near the center of the iron plate 62. While water was continuously circulated through the passage (not shown) to which the iron plate 62 is secured, a 2 kW blue laser light was impinged on the impingement site 66 on the iron plate 62 (the impingement site was measured to be approximately 5 cm in diameter) for 20 seconds. The flow rate of water through the water inlet 63 and water outlet 64 was set at a constant rate and the temperature rise in the water outlet 64 was attributed to the impingement of the 2 kW laser light onto the iron plate 62.

FIG. 11 is a chart revealing the results of the experiment illustrated in FIG. 10. The temperature sensors 68 inside the illuminated area 66 (those temperature sensors within the impingement site indicated by 2, 3, 6, 7), showed practically identical values, thus according to the observed values and the layout, their signals were treated as repetition and averaged. Two upstream sensors 68 (4, 8) were placed proximal to the water inlet 63 and two downstream sensors 68 (1, 5) were placed proximal to the water outlet 64.

The measured results are shown by the three distinct plots on FIG. 11. The solid line on FIG. 11 reveals the rapid rate at which the iron plate 62 warmed as indicated by the signals from the four temperature sensors that are disposed within the irradiated area 66 on FIG. 10. The temperature of this portion of the iron plate 62 increased rapidly until the impingement terminated at 20,000 ms, and then it began to taper off as the iron plate 62 began to cool. The heat introduced into the iron plate 62 was conducted to the two upstream sensors 68 proximal to the water inlet 63 as indicated by the dotted line on FIG. 11. It will be noted that the portion of the iron plate 62 proximal to the water inlet 63 begins to warm after an approximately 5-second delay, thereby modeling the warming that will occur within a fluid conduit as a result of irradiation by laser light. The heat introduced into the iron plate 62 was also conducted to the two downstream sensors 68 proximal to the water outlet 64 as indicated by the dashed line on FIG. 11. It will be noted that the portion of the iron plate 62 proximal to the water outlet 64 also begins to warm after an approximately 5-second delay, thereby modeling the warming that will occur within a fluid conduit as a result of irradiation by laser light. After the laser light impingement was terminated at 20,000 ms, the portion of the iron plate 66 proximal to the water inlet 63 cooled more quickly (as indicated by the decline in the dotted line) than the portion of the iron plate 62 proximal to the water outlet 4 as indicated by the decline in the dashed line) because the warmer portion of the iron plate 62 at the irradiated area 66 released heat to the water flow that moves in the direction of the water outlet 64.

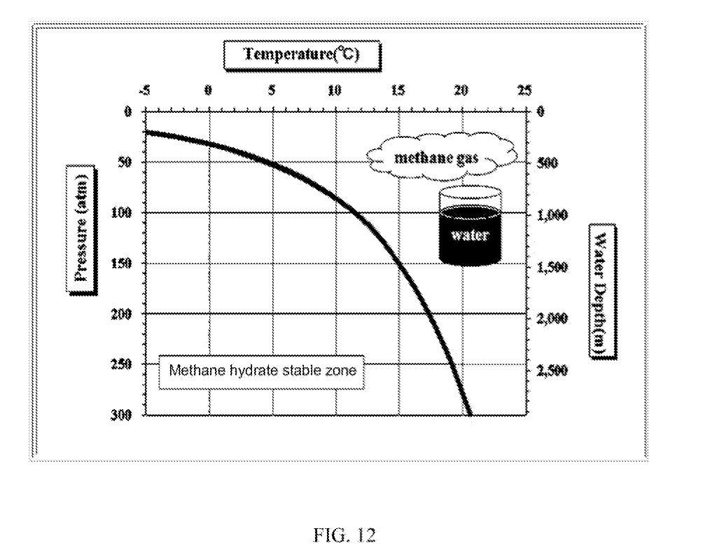

FIG. 12 is a methane hydrate stability chart. The required temperature increase within a restricted or methane hydrate blocked component of a fluid conduit may be specified based on the methane hydrate stability diagram illustrated in FIG. 12. This diagram is reproduced from http://www.mh21japan.gr.jp/english/mh21-1/02-2/, and shows the temperature at a given pressure that is required to decompose a methane hydrate blockage.

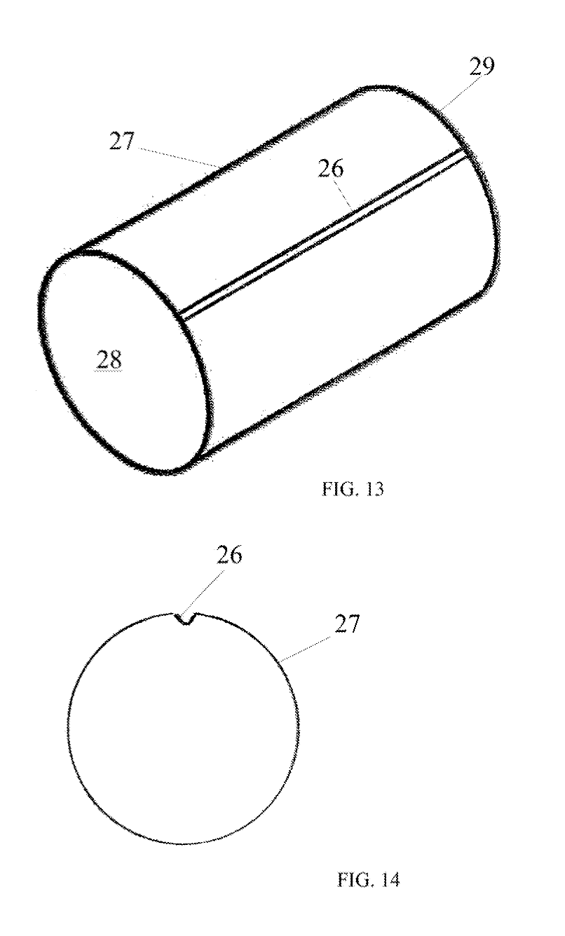

FIG. 13 is a perspective view of a methane hydrate deposit 27 that could present an obstacle or blockage to flow within a fluid conduit (not shown). The deposit 27 has an upstream end 28 and a downstream end 29. Tracing the impingement of a sport of blue laser light along a center of a fluid conduit (not shown) may be used to form a longitudinal channel 26 along the deposit 27 and from the upstream end 28 to the downstream end 29 to restore a minimal amount of flow within the fluid conduit. FIG. 14 is an end view of the deposit 27 of FIG. 13 showing the position of the channel 26 on the deposit 26.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the tbrm disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method of warming a submerged fluid conduit to remove a deposit of a material, comprising:
providing an electrical current source;
providing an umbilical including an electrical conduit having a first end connected to the electrical current source and a second end;
providing a submergible apparatus including an electrically-powered laser light generator connected to the second end of the electrical conduit and an optical frequency multiplier to condition laser light from the laser light generator that is introduced into the optical frequency multiplier;
submerging the submergible apparatus in a body of water in which the fluid conduit is submerged for transporting fluid from a fluid source to a fluid destination;
conducting an electrical current from the current source through the electrical conduit of the umbilical to the laser light generator;
generating laser light using the laser light generator;
introducing the laser light from the generator into the optical frequency multiplier to produce blue laser light;
directing the blue laser light from the submergible apparatus to impinge onto an exterior surface of the fluid conduit to irradiate the fluid conduit; and
warming at least a portion of the fluid conduit using the blue laser light.

2. The method of claim 1, wherein warming at least a portion of the fluid conduit using the blue laser light melts hydrates formed within the warmed portion of the fluid conduit.

3. The method of claim 1, wherein warming at least a portion of the fluid conduit using the blue laser light warms a volume of the fluid within the fluid conduit and flowing from the fluid source of the fluid conduit to the fluid destination of the fluid conduit to at least one of melt and deter formation of hydrates in a downstream portion of the fluid conduit.

4. The method of claim 1, further comprising:
providing a controllably positionable optical element to receive the blue laser light produced by the optical frequency multiplier;
moving the optical element to vary the path of the blue laser light produced by the optical frequency multiplier; and
irradiating a plurality of locations along the fluid conduit.

5. The method of claim 4, further comprising:
providing a camera on the submergible apparatus to generate a signal relating to the appearance of the irradiated portion of the fluid conduit; and
providing within the umbilical a camera signal conduit having a first end and a second end connected to the camera within the umbilical to transmit the signal generated by the camera.

6. The method of claim 5, further comprising:
connecting a monitor to the first end of the camera signal conduit to receive signals from the camera; and
monitoring the appearance of the irradiated portion of the fluid conduit using the monitor.

7. The method of claim 6, further comprising:
providing a controller to control the position of the optical element and to thereby vary the path of the blue laser light produced by the optical frequency multiplier; and
providing within the umbilical a controller control signal conduit having a first end connected to the controller and a second end connected to the controllably positionable optical element.

8. The method of claim 7, further comprising:
moving the controllably positionable optical element to trace the impingement of the blue laser light longitudinally along a component of a fluid conduit generally corresponding to the direction of flow of fluid therethrough to create a longitudinal channel along the periphery of a blockage within the component of the fluid conduit.

9. The method of claim 8, comprising:
at least one of reducing and equalizing the pressure differential across the blockage within the component of the fluid conduit by creation of the longitudinal channel; and
continue to move the controllably positionable optical element to trace the impingement of the blue laser light on the fluid conduit.

10. A method of warming a submerged fluid conduit to remove a deposit of a material, comprising:
providing an electrical current source;
providing an electrically-powered laser light generator;
providing an umbilical including an optical conduit having a first end connected to the laser light generator and a second end;
providing a submergible remotely operated vehicle having a optical frequency multiplier connected to the second end of the optical conduit to condition the laser light from the optical conduit;
submerging the vehicle in a body of water in which the fluid conduit is submerged for transporting fluid from a source to a destination;
transmitting laser light generated by the laser light generator through the optical conduit to the optical frequency multiplier of the vehicle;
producing blue laser light using the optical frequency multiplier;
directing the blue laser light from the vehicle onto an exterior surface of the fluid conduit; and
warming the fluid conduit using the impinging blue laser light.

11. A system for warming a submerged fluid conduit, comprising:
a non-submerged electrical power source;
a submerged laser light generator on a submergible vehicle;
an optical frequency multiplier disposed on the submergible vehicle and optically coupled to receive laser light generated by the laser light generator and to convert the received laser light into blue laser light;
an umbilical comprising an electrical conduit with a first end connectable to the electrical power source and a second end connectable to the laser light generator; and
a submergible laser head to receive the blue laser light from the optical frequency multiplier and to emit a blue laser light beam for transmission through water to irradiate a fluid conduit with blue laser light.

12. The system of claim 11, further comprising:
a camera provided on the submergible vehicle to convert an image of the fluid conduit to a camera signal; and
a camera signal conduit having a second end connectable to the camera and a first end connectable to a non-submerged display device.

13. The system of claim 12, further comprising:
a manipulator arm on the vehicle to position the laser head for directing of the blue laser beam transmitted therethrough;
an actuator for positioning the manipulator arm;
an actuator control signal conduit having a second end connectable to the actuator; and
a non-submerged controller connectable to a first end of the actuator control signal conduit for generating signals to the actuator for positioning the laser head to direct blue laser light.

14. The system of claim 11, wherein the umbilical further includes a cable having a first end connectable to a vessel and a second end connectable to the vehicle for supporting the weight of the vehicle and for retrieving the vehicle from a submerged location.

15. A system for warming a submerged fluid conduit, comprising:
a non-submerged electrical power source;
a non-submerged infrared laser light generator connected to receive electrical current from the electrical power source;
an optical frequency multiplier disposed on the submergible vehicle and optically coupled to receive laser light generated by the laser light generator and to convert the received laser light into blue laser light;
an umbilical comprising an optically conductive conduit with a first end connectable to the laser light generator and a second end connectable to the optical frequency multiplier to transmit infrared laser light from the laser light generator to the optical frequency multiplier; and
a submergible laser head to receive the blue laser light horn the optical frequency multiplier and to emit a blue laser light beam for transmission through water to indicate a fluid conduit with blue laser light.

16. The system of claim 15, further comprising:
a camera provided on the submergible vehicle to convert an image of the fluid conduit to a camera signal; and
a camera signal conduit having a second end connectable to the camera and a first end connectable to a non-submerged display device.

17. The system of claim 16, further comprising:
a manipulator arm on the vehicle to position the laser head for directing of the blue laser beam transmitted therethrough;
an actuator for positioning the manipulator arm;
an actuator control signal conduit having a second end connectable to the actuator; and
a non-submerged controller connectable to a first end of the actuator control signal conduit for generating signals to the actuator for positioning the laser head to direct blue laser light.

18. The system of claim 15, wherein the umbilical further includes a cable having a first end connectable to a vessel and a second end connectable to the vehicle for supporting the weight of the vehicle and for retrieving the vehicle from a submerged location.
